(19) United States
(12) Patent Application Publication
(10) Pub. No.: US 2017/0210016 A1
(43) Pub. Date: Jul. 27, 2017

(54) ROBOT

(71) Applicant: Seiko Epson Corporation, Tokyo (JP)

(72) Inventors: Sho NAKANO, Matsumoto (JP); Yoshinobu GOTO, Azumino (JP)

(21) Appl. No.: 15/405,624

(22) Filed: Jan. 13, 2017

(30) Foreign Application Priority Data
Jan. 25, 2016 (JP) 2016-011298

(51) Int. Cl. B25J 19/00

(52) U.S. Cl. CPC B25J 19/0029

(57) ABSTRACT

A robot includes a first arm that has a drive unit, a second arm that is disposed in the first arm, and that can be displaced with respect to the first arm by the drive unit, and a flexible member that is fixed to the first arm by a first fixing portion, and that is fixed to the second arm by a second fixing portion. The flexible member has a folding portion disposed between the first fixing portion and the second fixing portion, a first portion disposed between the first fixing portion and the folding portion, and a second portion disposed between the second fixing portion and the folding portion. At least one of the first portion and the second portion has a uniform portion both in a state where the drive unit is driven and in a state where the drive unit is not driven.

### BACKGROUND

1. Technical Field

The present invention relates to a robot.

2. Related Art

In the related art, a robot including a robot arm is known. In the robot arm, multiple arms (arm members) are linked to each other via joint portions. For example, a hand serving as an end effector is mounted on the arm on the most distal end side (most downstream side). The joint portions are driven by a motor, and the joint portions are driven, thereby pivoting the arm. For example, the robot grips a target with the hand, moves the target to a predetermined place, and carries out predetermined work such as assembly. For the purpose of space saving in a factory, it is desired to provide a miniaturized robot which can perform operations in a wide range.

In order to prepare this robot, it is necessary not only to effectively utilize an internal space of the robot, but also to secure a required operation range.

JP-A-2013-66985 discloses a robot having a U-shaped wiring structure of cables, as one of structures which can effectively utilize the internal space of the robot.

However, according to the robot disclosed in JP-A-2013-66985, nothing has been studied on how the cables relate to the internal space of the robot or how large angle enables the arm to pivot. Therefore, if a pivot angle of the arm is too large, an excessive load is applied to the cables, thereby causing a possibility that the cables are disconnected at an early stage.

### SUMMARY

An advantage of some aspects of the invention is to solve at least a part of the problems described above, and the invention can be implemented as the following forms or application examples.

An aspects of the invention is directed to a robot including a first arm that has a drive unit, a second arm that is disposed in the first arm, and that can be displaced with respect to the first arm by the drive unit, and a flexible member that is fixed to the first arm by a first fixing portion, and that is fixed to the second arm by a second fixing portion. The flexible member has a folding portion disposed between the first fixing portion and the second fixing portion, a first portion disposed between the first fixing portion and the folding portion, and a second portion disposed between the second fixing portion and the folding portion. At least one of the first portion and the second portion has a uniform portion both in a state where the drive unit is driven and in a state where the drive unit is not driven.

According to this configuration, in a case where the robot is operated, it is possible to restrain an excessive load from being applied to the flexible member. In this manner, in a case where the robot is operated, it is possible to restrain the flexible member from being disconnected at an early stage. In addition, it is possible to effectively utilize an internal space of the robot.

In the robot, it is preferable that the flexible member has an elongated shape, and that a longitudinal length of the uniform portion is longer than a radius of the flexible member.

According to this configuration, in a case where the robot is operated, it is possible to more reliably restrain an excessive load from being applied to the flexible member.

In the robot, it is preferable that the flexible member has an elongated shape, and that a longitudinal length of the uniform portion is longer than a diameter of the flexible member.

According to this configuration, in a case where the robot is operated, it is possible to more reliably restrain an excessive load from being applied to the flexible member.

In the robot, it is preferable that the flexible member has an elongated shape, and that a longitudinal length of the uniform portion is longer than 3 mm.

According to this configuration, in a case where the robot is operated, it is possible to more reliably restrain an excessive load from being applied to the flexible member.

In the robot, it is preferable that the flexible member has an elongated shape, that the second arm is disposed in the first arm so as to be pivotable around a pivot shaft, and that when an outer diameter of a portion having the folding portion, the first portion, and the second portion is set to X, a length in an axial direction of the pivot shaft of the portion having the folding portion, the first portion, and the second portion is set to Y, and a diameter of the flexible member is set to Z, a longitudinal length of the uniform portion is shorter than a half of [(X−Z)×π/2−Y/2].

According to this configuration, it is possible to restrain the length of the uniform portion from becoming unnecessarily longer, and to restrain the required internal space of the robot from being widened in order to install the flexible member. In this manner, it is possible to provide a thinner robot arm.

In the robot, it is preferable that the flexible member is provided at two locations.

According to this configuration, compared to a case where the flexible member is provided at one location, it is possible to cause the thickness of the flexible member to be thinner, and it is possible to provide a thinner robot arm.

In the robot, it is preferable that the folding portion of one flexible member and the folding portion of the other flexible member are disposed so as to face each other.

According to this configuration, the two folding portions can be efficiently disposed.

In the robot, it is preferable that the flexible member has at least one of a wire and a pipe.

According to this configuration, in a case where the robot is operated, it is possible to restrain an excessive load from being applied to at least anyone of the wire and the pipe.

In the robot, it is preferable that the first arm is pivotable around a first pivot shaft, and that the second arm is pivotable around a second pivot shaft.

According to this configuration, it is possible to easily carry out various types of work.

In the robot, it is preferable that the flexible member has an elongated shape, that the second arm is disposed in the first arm so as to be pivotable around a pivot shaft, and that when the maximum pivot angle of the second arm is set to θ(°), an outer diameter of a portion having the folding portion, the first portion, and the second portion is set to X, a length in an axial direction of the pivot shaft of the portion having the folding portion, the first portion, and the second portion is set to Y, a diameter of the flexible member is set to Z, and a length of the flexible member in a direction perpendicular to an axial direction of the pivot shaft, which is required for fixation using the first fixing portion or the second fixing portion is set to C, the above-described θ, X, Y, Z, and C are set to satisfy Expression (1) below.

[(X−Z)×π/2−Y/2]−[(X−Z)×π/4×θ/180]−C>0 (1)

According to this configuration, in a case where the robot is operated, it is possible to easily and quickly design a robot which can restrain an excessive load from being applied to the flexible member.

### BRIEF DESCRIPTION OF THE DRAWINGS

The invention will be described with reference to the accompanying drawings, wherein like numbers reference like elements.

FIG. 1 is a perspective view illustrating an embodiment of a robot according to the invention.

FIG. 2 is a schematic view of the robot illustrated in FIG. 1.

FIG. 3 is a side view of the robot illustrated in FIG. 1.

FIG. 4 is a front view of the robot illustrated in FIG. 1.

FIG. 5 is a front view of the robot illustrated in FIG. 1.

FIG. 6 is a view for describing an operation when the robot illustrated in FIG. 1 carries out work.

FIG. 7 is a perspective view illustrating a state where an inner cover portion of a first arm of the robot illustrated in FIG. 1 is detached.

FIG. 8 is a perspective view illustrating a state where the inner cover portion and an outer cover portion of the first arm of the robot illustrated in FIG. 1 are detached.

FIG. 9 is a view for describing a cable arrangement of the robot illustrated in FIG. 1.

FIG. 10 is a view for describing a cable arrangement of the robot illustrated in FIG. 1.

FIG. 11 is a view for describing a cable arrangement of the robot illustrated in FIG. 1.

FIG. 12 is a view for describing a cable arrangement and dimensions of each unit in the robot illustrated in FIG. 1.

FIG. 13 is a plan view for describing the cable arrangement and the dimensions of each unit in the robot illustrated in FIG. 1.

FIG. 14 is a sectional view for describing the cable arrangement and the dimensions of each unit in the robot illustrated in FIG. 1.

### DESCRIPTION OF EXEMPLARY EMBODIMENTS

Hereinafter, a preferable embodiment of a robot according to the invention will be described in detail with reference to the accompanying drawings.

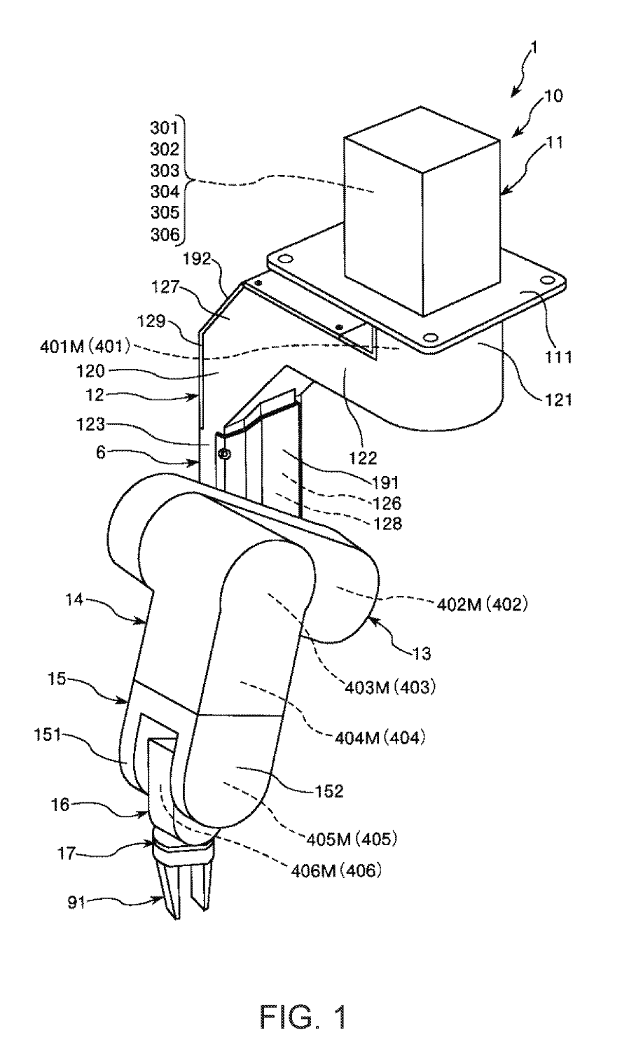

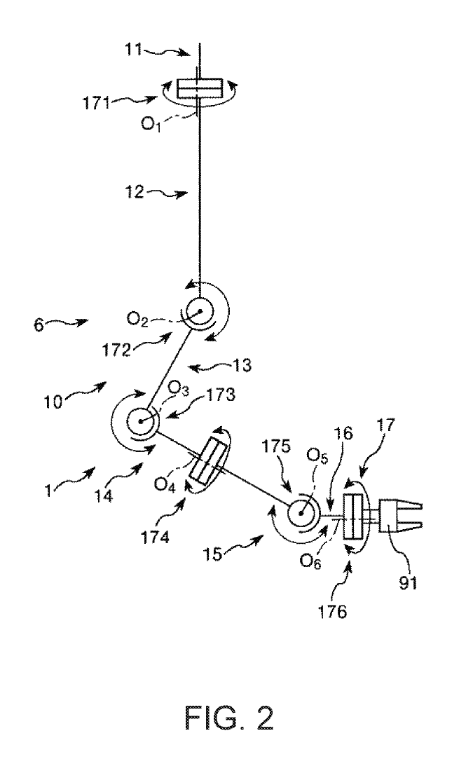

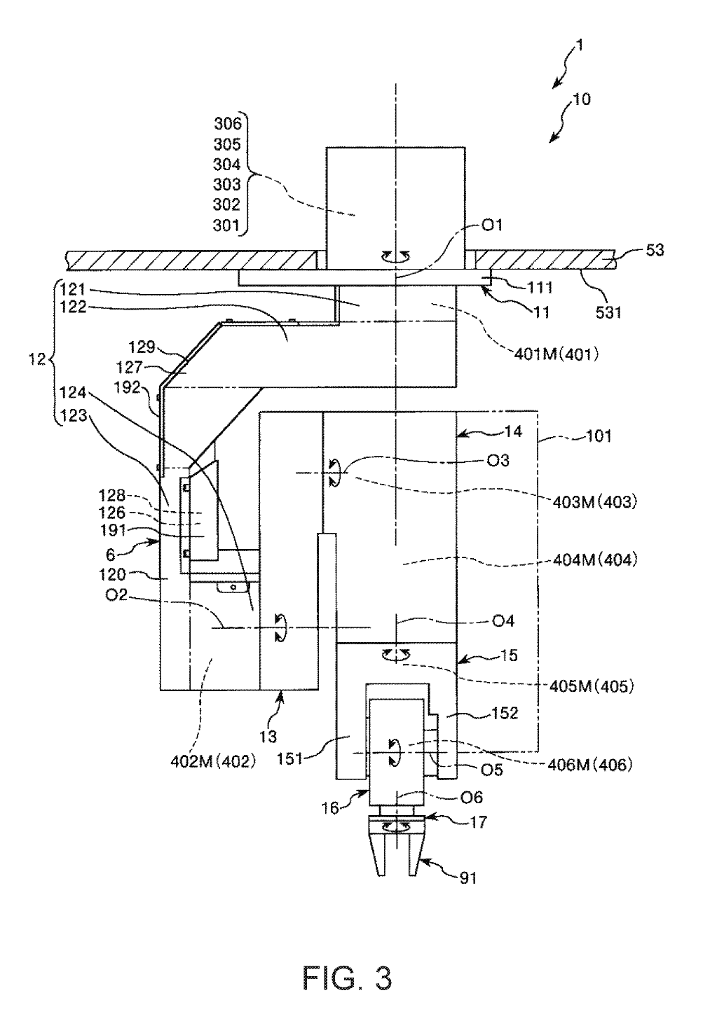

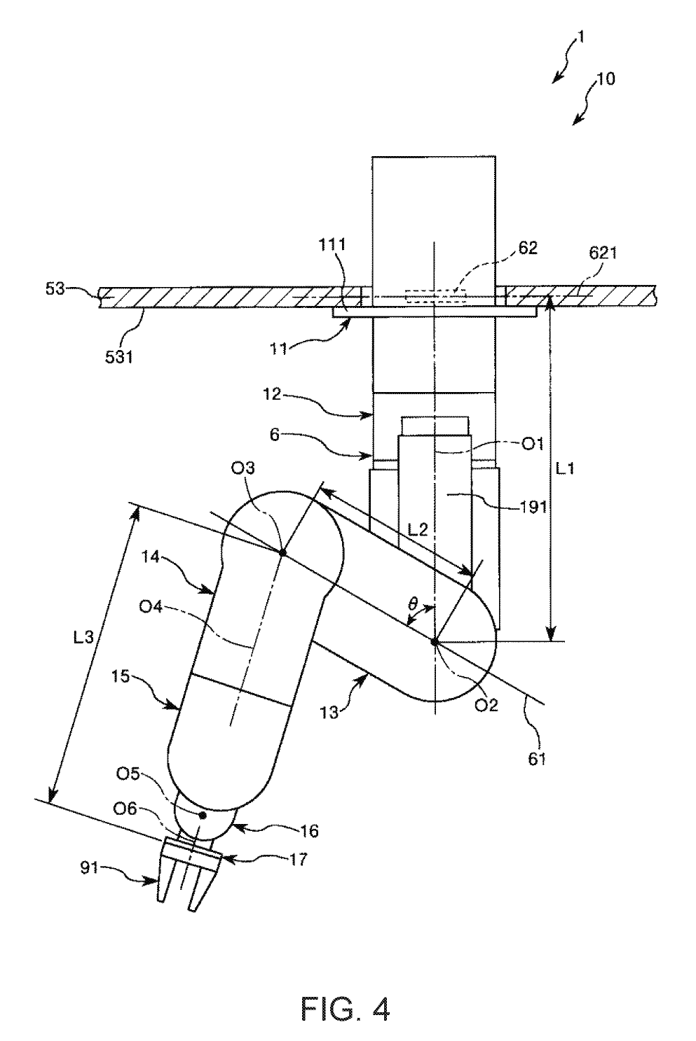

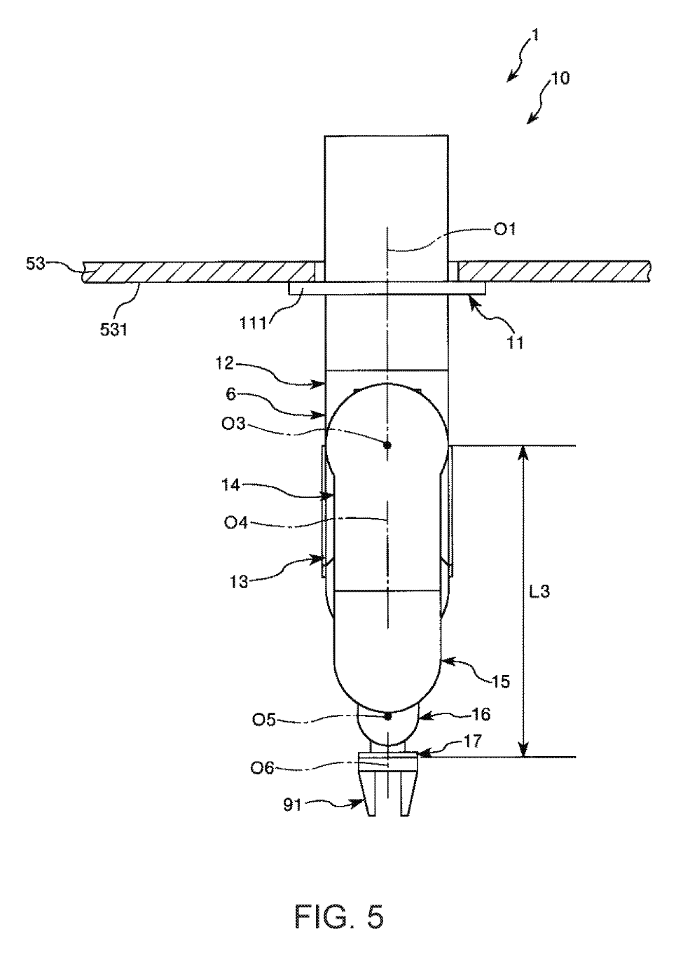

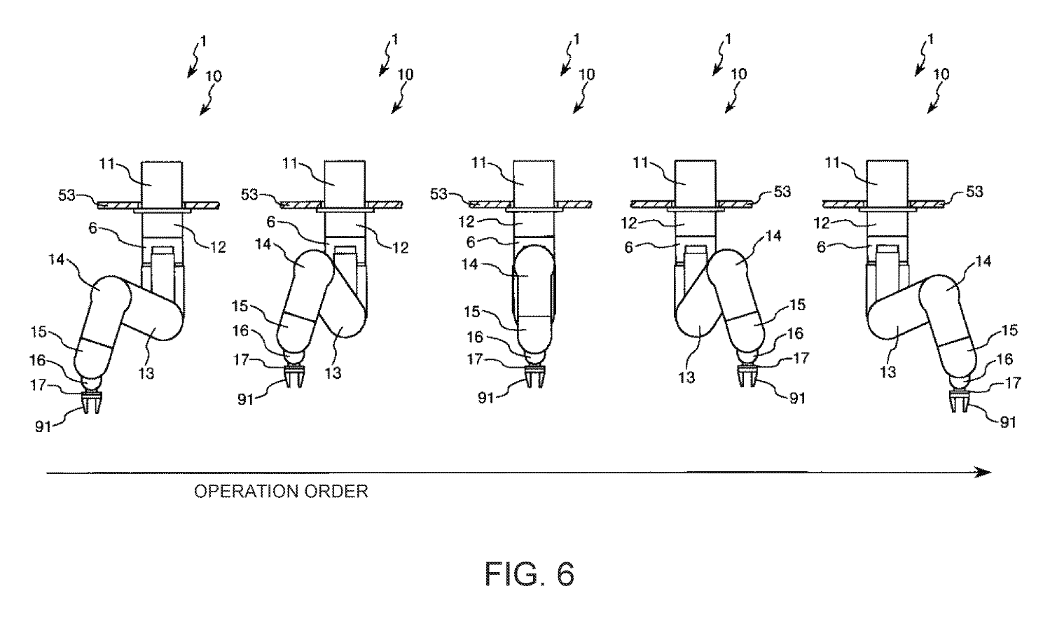

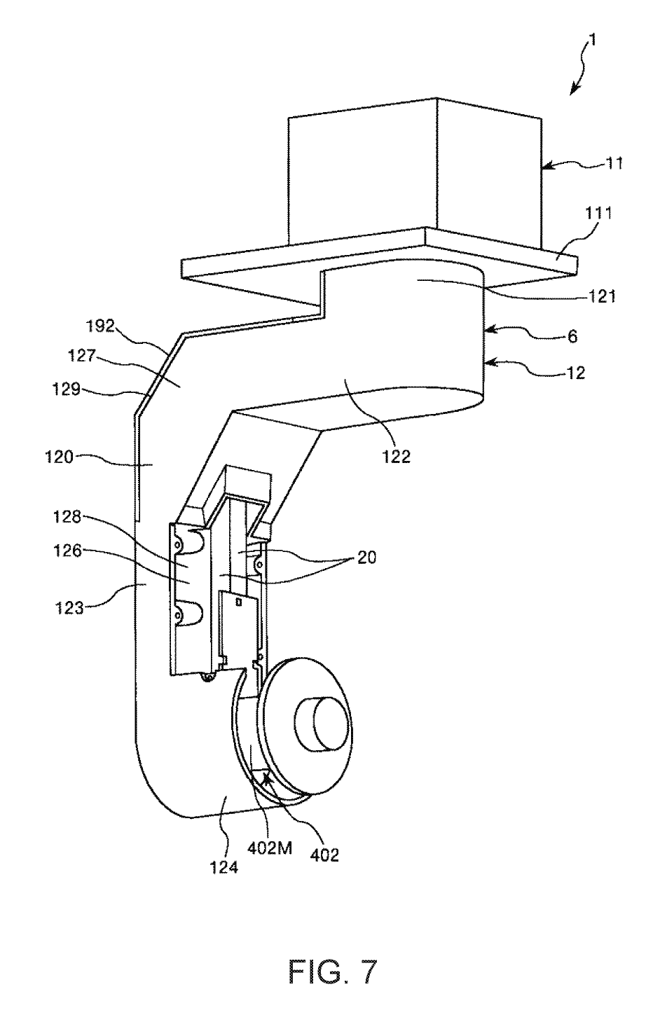

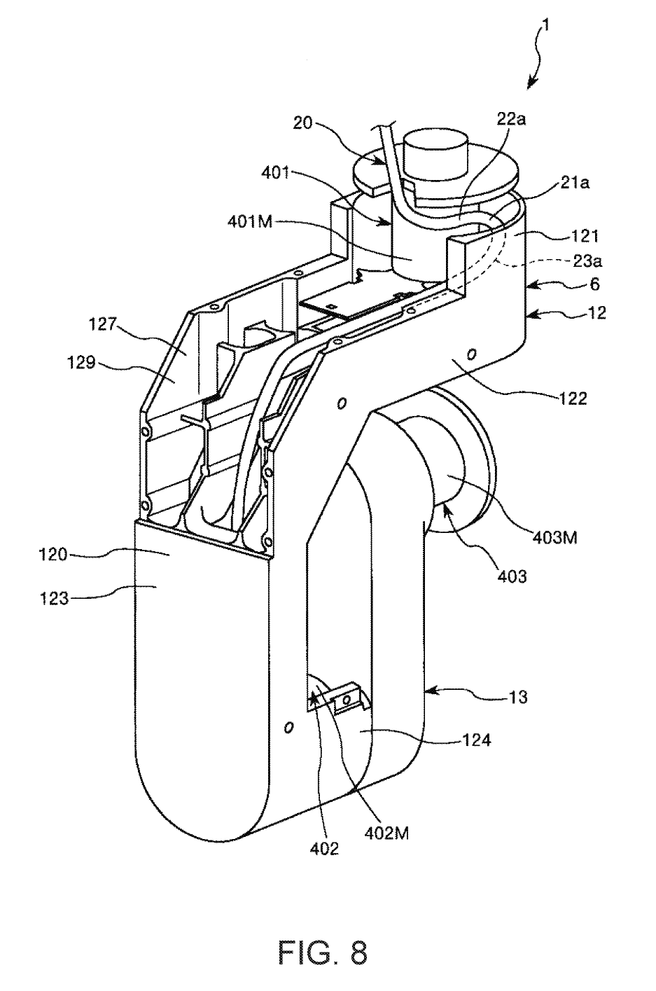

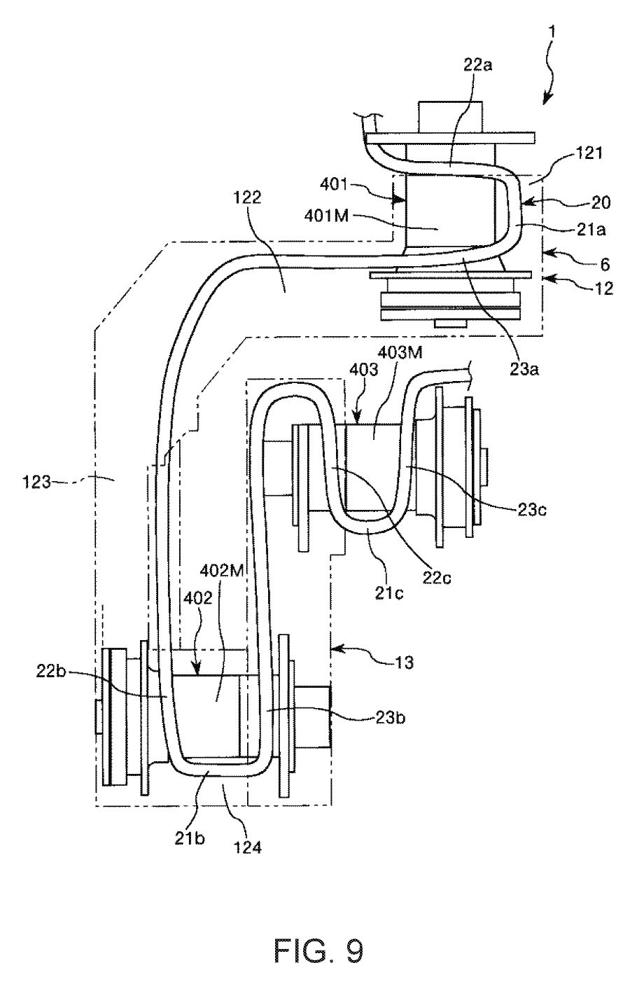

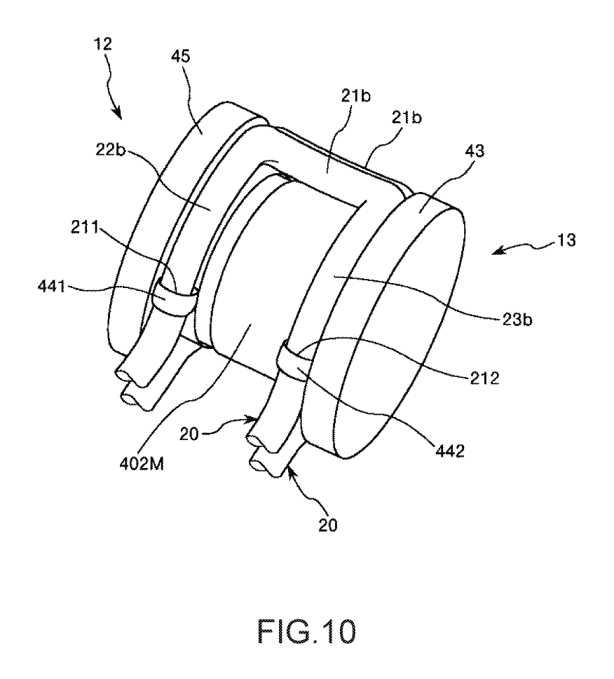

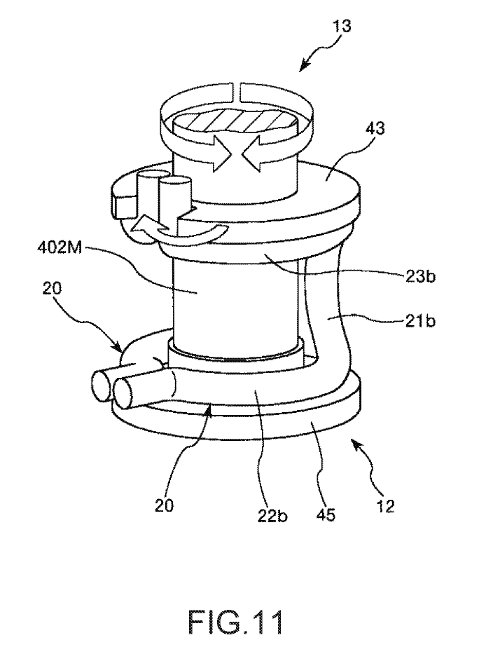

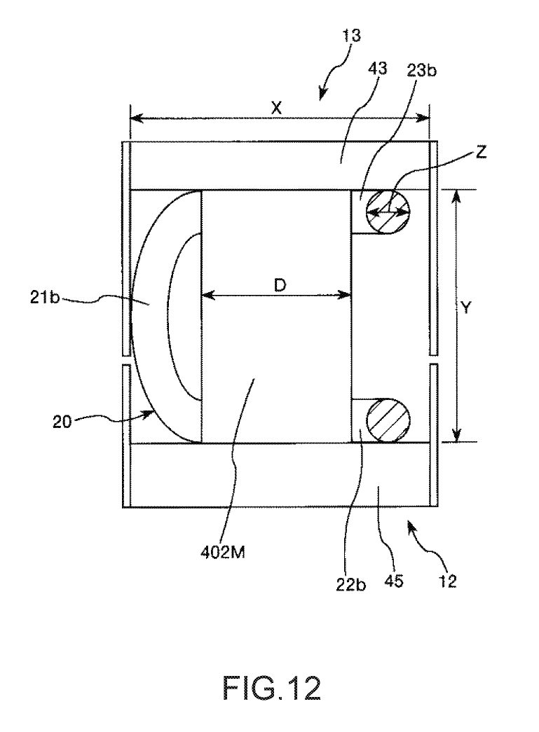

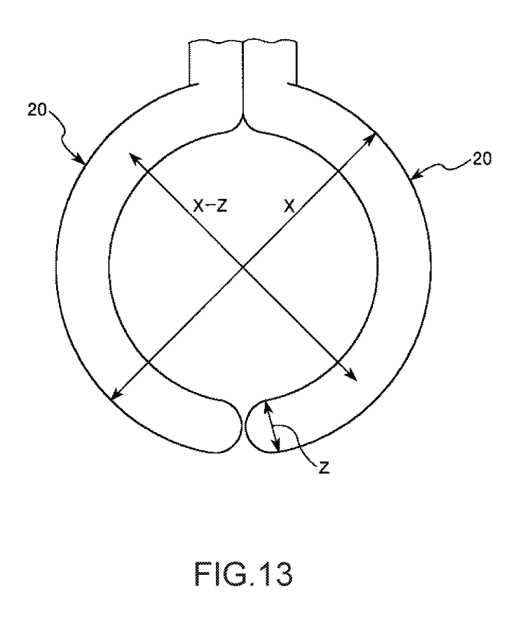

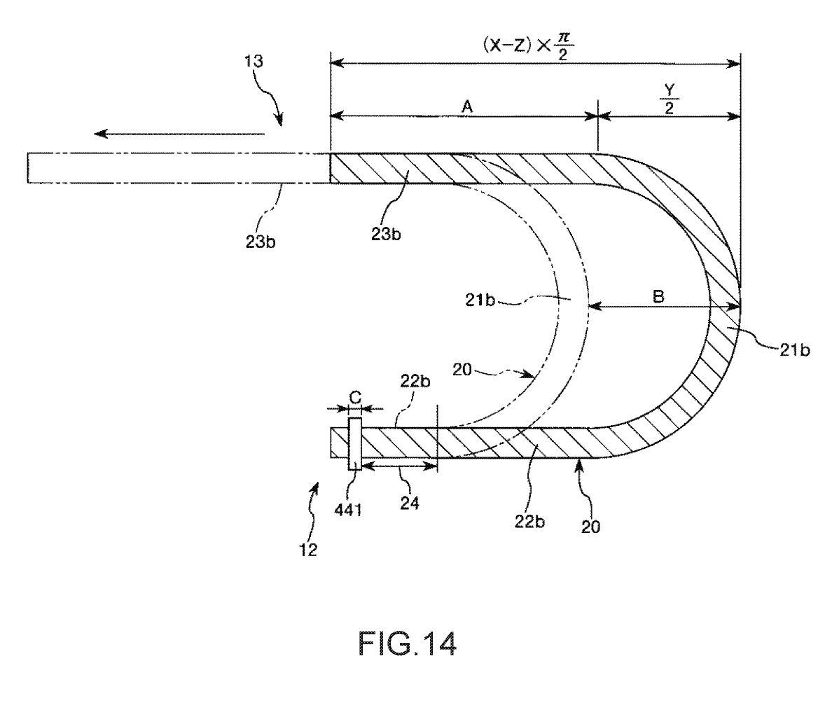

FIG. 1 is a perspective view illustrating the embodiment of the robot according to the invention. FIG. 2 is a schematic view of the robot illustrated in FIG. 1. FIG. 3 is a side view of the robot illustrated in FIG. 1. FIG. 4 is a front view of the robot illustrated in FIG. 1. FIG. 5 is a front view of the robot illustrated in FIG. 1. FIG. 6 is a view for describing an operation when the robot illustrated in FIG. 1 carries out work. FIG. 7 is a perspective view illustrating a state where an inner cover portion of a first arm of the robot illustrated in FIG. 1 is detached. FIG. 8 is a perspective view illustrating a state where the inner cover portion and an outer cover portion of the first arm of the robot illustrated in FIG. 1 are detached. FIG. 9 is a view for describing a cable arrangement of the robot illustrated in FIG. 1. FIG. 10 is a view for describing a cable arrangement of the robot illustrated in FIG. 1. FIG. 11 is a view for describing a cable arrangement of the robot illustrated in FIG. 1. FIG. 12 is a view for describing a cable arrangement and dimensions of each unit in the robot illustrated in FIG. 1. FIG. 13 is a plan view for describing the cable arrangement and the dimensions of each unit in the robot illustrated in FIG. 1, that is, a view when a cable is viewed from an upper side in FIGS. 11 and 12. FIG. 14 is a sectional view for describing the cable arrangement and the dimensions of each unit in the robot illustrated in FIG. 1. FIG. 14 is a sectional view in a case where the cable is cut out by a center line thereof.

Hereinafter, in order to facilitate description, an upper side in FIGS. 1 and 3 to 9 is referred to as “up” or “upward”, and a lower side is referred to as “down” or “downward”. A base side in FIGS. 1 to 9 is referred to as a “proximal end” or “upstream”, and a side opposite thereto (hand side) is referred to as a “distal end” or “downstream”. An upward and downward direction in FIGS. 1 and 3 to 9 represents a vertical direction. FIGS. 8 and 9 illustrate only one of two cables. In FIGS. 8, 9, and 11, illustration of a fixing member is omitted. In FIG. 14, illustration of one fixing member is omitted. A cross section in FIGS. 12 and 14 is simplified, and is illustrated by diagonal lines.

A robot (industrial robot) 1 illustrated in FIG. 1 includes a robot main body (main body) 10 and a control device (not illustrated, robot control device) that controls an operation of the robot main body 10 (robot 1). For example, the robot 1 can be used for a manufacturing process of manufacturing precision instruments such as wristwatches. For example, the robot 1 can carry out each work for supplying, removing, transporting, and assembling the precision instruments or components configuring the precision instruments.

The control device may be incorporated in the robot main body 10 (robot 1), or maybe a separate body from the robot main body 10. However, according to the present embodiment, the control device is disposed in a base 11 (to be described later) of the robot main body 10. For example, the control device can be configured to include a personal computer (PC) having a central processing unit (CPU) incorporated therein.

As illustrated in FIGS. 1 to 3, the robot main body 10 has the base (support portion) 11 and a robot arm 6. The robot arm 6 includes a first arm (first arm member) (arm portion) 12, a second arm (second arm member) (arm portion) 13, a third arm (third arm member) (arm portion) 14, a fourth arm (fourth arm member) (arm portion) 15, a fifth arm (fifth arm member) (arm portion) 16, and a sixth arm (sixth arm member) (arm portion) 17 (six arms), a first drive device 401, a second drive device 402, a third drive device 403, a fourth drive device 404, a fifth drive device 405, and a sixth drive device 406 (six drive sources). A wrist is configured to include the fifth arm 16 and the sixth arm 17. For example, an end effector such as a hand 91 can be detachably attached to a distal end of the sixth arm 17.

The robot 1 is a vertically articulated (six axes) robot in which the base 11, the first arm 12, the second arm 13, the third arm 14, the fourth arm 15, the fifth arm 16, and the sixth arm 17 are linked in this order from a proximal end side toward a distal end side. Hereinafter, the first arm 12, the second arm 13, the third arm 14, the fourth arm 15, the fifth arm 16, and the sixth arm 17 are respectively referred to as “arms”. The first drive device 401, the second drive device 402, the third drive device 403, the fourth drive device 404, the fifth drive device 405, and the sixth drive device 406 are respectively referred to as “drive sources”.

As illustrated in FIG. 3, the base 11 is a portion fixed (portion attached) to a ceiling surface 531 of a ceiling (ceiling portion) 53 in an installation space. The ceiling surface 531 is a plane parallel to a horizontal plane. Without being particularly limited, as a fixing method of the base 11, it is possible to employ a fixing method using multiple bolts, for example.

According to the embodiment, a plate-shaped flange 111 disposed in a distal end portion of the base 11 is attached to the ceiling surface 531. However, without being limited thereto, a location for attaching the base 11 to the ceiling surface 531 may be a proximal end surface (an upper side end surface in FIG. 3) of the base 11, for example.

In the robot 1, a connection portion between the base 11 and the robot arm 6, that is, a center line (center) 621 (refer to FIG. 4) of a bearing portion 62 (to be described later) is located above the ceiling surface 531 in a vertical direction. For example, without being limited thereto, the center of the bearing portion 62 may be located below the ceiling surface 531 in the vertical direction, or may be located at a position which is the same as that of the ceiling surface 531 in the vertical direction.

In the robot 1, the base 11 is installed on the ceiling surface 531. Accordingly, a connection portion between the first arm 12 and the second arm 13, that is, a center line (center) of a bearing portion (not illustrated) for supporting the second arm 13 so as to be pivotable is located below the center line 621 of the bearing portion 62 in the vertical direction.

The base 11 may include a joint 171 (to be described later), or may not include the joint 171 (refer to FIG. 2).

The first arm 12, the second arm 13, the third arm 14, the fourth arm 15, the fifth arm 16, and the sixth arm 17 are respectively supported so as to be displaceable independently of the base 11.

As illustrated in FIGS. 1 and 3, the first arm 12 has a hollow portion. The first arm 12 has a main body 120, and cover portions 191 and 192 which are detachably disposed in the main body 120. In this case, an opening 129 is formed in an outer portion 127 of the first arm 12. The cover portion 192 is detachably disposed so as to cover the opening 129. An opening 128 is formed in an inner portion 126 of the first arm 12, and the cover portion 191 is detachably disposed so as to cover the opening 128. In this manner, accessibility to the inside of the first arm 12 is improved, thereby enabling a user to easily carry out each work of inspection, repair, and replacement for each unit such as a wire or a substrate disposed inside the first arm 12.

The cover portion 191 covers the entire opening 128. However, without being limited thereto, the cover portion 191 may cover a portion of the opening 128. Similarly, the cover portion 192 covers the entire opening 129. However, without being limited thereto, the cover portion 192 may cover a portion of the opening 129.

The cover portions 191 and 192 may be respectively configured to include a single member, or may be configured to include multiple members.

As illustrated in FIGS. 1 to 3, the first arm 12 has a bent shape. If the first arms 12 is described in a state illustrated in FIG. 3, the first arm 12 has a first portion 121 connected to the base 11 and extending downward in FIG. 3 in the axial direction (vertical direction) of a first pivot shaft O1 (to be described later) from the base 11, a second portion 122 extending leftward in FIG. 3 in the axial direction (horizontal direction) of a second pivot shaft O2 from a lower end (in FIG. 3) of the first portion 121, a third portion 123 disposed in an end portion of the second portion 122, which is opposite to the first portion 121, and extending downward in FIG. 3 in the axial direction (vertical direction) of the first pivot shaft O1, and a fourth portion 124 extending rightward in FIG. 3 in the axial direction (horizontal direction) of the second pivot shaft O2 from an end portion of the third portion 123, which is opposite to the second portion 122. The first portion 121, the second portion 122, the third portion 123, and the fourth portion 124 are integrally formed. The second portion 122 and the third portion 123 are substantially orthogonal to each other (cross each other) when viewed in a direction orthogonal to both the first pivot shaft O1 and the second pivot shaft O2 (when viewed from the front of the paper surface in FIG. 3).

The second arm 13 has a longitudinal shape, and is connected to a distal end portion of the first arm 12, that is, an end portion of the fourth portion 124, which is opposite to the third portion 123.

The third arm 14 has a longitudinal shape, and is connected to a distal end portion of the second arm 13, that is, an end portion opposite to an end portion of the second arm 13 to which the first arm 12 is connected.

The fourth arm 15 is connected to a distal end portion of the third arm 14, that is, an end portion opposite to an end portion of the third arm 14 to which the second arm 13 is connected. The fourth arm 15 has a pair of support portions 151 and 152 facing each other. The support portions 151 and 152 are used in connecting the fourth arm 15 and the fifth arm 16 to each other.

The fifth arm 16 is located between the support portions 151 and 152, and is connected to the support portions 151 and 152, thereby being linked to the fourth arm 15. Without being limited to this structure, for example, the fourth arm 15 may have one support portion (cantilevered structure).

The sixth arm 17 has a flat plate shape, and is connected to a distal end portion of the fifth arm 16. As an end effector, for example, a hand 91 for gripping a precision instrument such as a wristwatch or a component is detachably mounted on a distal end portion of the sixth arm 17 (end portion opposite to the fifth arm 16). The drive of the hand 91 is controlled by the control device. Without being particularly limited, the hand 91 includes a configuration having multiple finger portions (fingers), for example. The robot 1 controls the arms 12 to 17 while gripping the precision instrument or the component with the hand 91. In this manner, the robot 1 can carry out each work such as a work for transporting the precision instrument or the component.

As illustrated in FIGS. 1 to 3, the base 11 and the first arm 12 are linked to each other via the joint 171. The joint 171 has a mechanism for supporting the mutually linked first arm 12 so as to be pivotable with respect to the base 11. In this manner, the first arm 12 is pivotable around the center of the first pivot shaft O1 (around the first pivot shaft O1) parallel to the vertical direction with respect to the base 11. The first pivot shaft O1 is coincident with a normal line of the ceiling surface 531 of the ceiling 53 to which the base 11 is attached. The first pivot shaft O1 is located on the most upstream side of the robot 1. The first arm 12 is pivoted (driven) around the first pivot shaft O1 by driving the first drive device 401 which has a motor (first motor) 401M serving as a drive unit (first drive unit) and a speed reducer (not illustrated) and which is mounted (disposed) on a mounting surface of the first arm 12 and a mounting surface of the base 11. The first drive device 401 is driven by the motor 401M and a cable 20 (refer to FIG. 9). The motor 401M is controlled by the control device via an electrically connected motor driver 301. The speed reducer may be omitted therefrom.

In the embodiment, the first arm 12 does not have a brake (braking device) for braking the first arm 12. However, without being limited thereto, for example, similarly to other arms, as the brake for braking the first arm 12, a brake (not illustrated) such as an electromagnetic brake may be disposed in the vicinity of a shaft portion (output shaft) of the motor 401M.

The first arm 12 and the second arm 13 are linked to each other via a joint 172. The joint 172 has a mechanism for supporting the first arm 12 and the second arm 13 which are linked to each other so that one is pivotable with respect to the other one. In this manner, the second arm 13 is pivotable around the center of the second pivot shaft O2 (around the second pivot shaft O2) parallel to the horizontal direction with respect to the first arm 12. The second pivot shaft O2 is orthogonal to the first pivot shaft O1. The second arm 13 is pivoted (driven) around the second pivot shaft O2 by driving the second drive device 402 which has a motor (second motor) 402M serving as a drive unit (second drive unit) and a speed reducer (not illustrated) and which is mounted (disposed) on a mounting surface of the second arm 13 and the mounting surface of the first arm 12. The second drive device 402 is driven by the motor 402M and the cable 20 (refer to FIG. 9). The motor 402M is controlled by the control device via an electrically connected motor driver 302. The speed reducer may be omitted therefrom.

As a brake (braking device) for braking the second arm 13, a brake (not illustrated) is disposed in the vicinity of a shaft portion (output shaft) of the motor 402M. The brake can inhibit the shaft portion of the motor 402M from being pivoted, and can hold a posture of the second arm 13.

The second pivot shaft O2 may be parallel to an axis orthogonal to the first pivot shaft O1. The second pivot shaft O2 may not be orthogonal to the first pivot shaft O1. Both axial directions may be different from each other.

The second arm 13 and the third arm 14 are linked to each other via a joint 173. The joint 173 has a mechanism for supporting the second arm 13 and the third arm 14 which are linked to each other so that one is pivotable with respect to the other one. In this manner, the third arm 14 is pivotable around the center of a third pivot shaft O3 (around the third pivot shaft O3) parallel to the horizontal direction with respect to the second arm 13. The third pivot shaft O3 is parallel to the second pivot shaft O2. The third arm 14 is pivoted (driven) around the third pivot shaft O3 by driving the third drive device 403 which has a motor (third motor) 403M serving as a drive unit (third drive unit) and a speed reducer (not illustrated) and which is mounted (disposed) on amounting surface of the third arm 14 and the mounting surface of the second arm 13. The third drive device 403 is driven by the motor 403M and the cable 20 (refer to FIG. 9). The motor 403M is controlled by the control device via an electrically connected motor driver 303. The speed reducer may be omitted therefrom.

As a brake (braking device) for braking the third arm 14, a brake (not illustrated) is disposed in the vicinity of a shaft portion (output shaft) of the motor 403M. The brake can inhibit the shaft portion of the motor 403M from being pivoted, and can hold a posture of the third arm 14.

The third arm 14 and the fourth arm 15 are linked to each other via a joint 174. The joint 174 has a mechanism for supporting the third arm 14 and the fourth arm 15 which are linked to each other so that one is pivotable with respect to the other one. In this manner, the fourth arm 15 is pivotable around the center of a fourth pivot shaft O4 (around the fourth pivot shaft O4) parallel to the central axis direction of the third arm 14 with respect to the third arm 14 (base 11). The fourth pivot shaft O4 is orthogonal to the third pivot shaft O3. The fourth arm 15 is pivoted (driven) around the fourth pivot shaft O4 by driving the fourth drive device 404 which has a motor (fourth motor) 404M serving as a drive unit (fourth drive unit) and a speed reducer (not illustrated) and which is mounted (disposed) on a mounting surface of the fourth arm 15 and the mounting surface of the third arm 14. The fourth drive device 404 is driven by the motor 404M and a cable (not illustrated). The motor 404M is controlled by the control device via an electrically connected motor driver 304. The speed reducer may be omitted therefrom.

As a brake (braking device) for braking the fourth arm 15, a brake (not illustrated) is disposed in the vicinity of a shaft portion (output shaft) of the motor 404M. The brake can inhibit the shaft portion of the motor 404M from being pivoted, and can hold a posture of the fourth arm 15.

The fourth pivot shaft O4 maybe parallel to an axis orthogonal to the third pivot shaft O3. The fourth pivot shaft O4 may not be orthogonal to the third pivot shaft O3. Both axial directions may be different from each other.

The fourth arm 15 and the fifth arm 16 are linked to each other via a joint 175. The joint 175 has a mechanism for supporting the fourth arm 15 and the fifth arm 16 which are linked to each other so that one is pivotable with respect to the other one. In this manner, the fifth arm 16 is pivotable around the center of a fifth pivot shaft O5 (around the fifth pivot shaft O5) orthogonal to the central axis direction of the fourth arm 15 with respect to the fourth arm 15. The fifth pivot shaft O5 is orthogonal to the fourth pivot shaft O4. The fifth arm 16 is pivoted (driven) around the fifth pivot shaft O5 by driving the fifth drive device 405 which is mounted on amounting surface of the fifth arm 16 and the mounting surface of the fourth arm 15. The fifth drive device 405 has the motor (fifth motor) 405M serving as the drive unit (fifth drive unit), a speed reducer (not illustrated), a first pulley (not illustrated) linked to a shaft portion of the motor 405M, a second pulley (not illustrated) disposed away from the first pulley and linked to a shaft portion of the speed reducer, and a belt (not illustrated) laid between the first pulley and the second pulley. The fifth drive device 405 is driven by the motor 405M and a cable (not illustrated). The motor 405M is controlled by the control device via an electrically connected motor driver 305. The speed reducer maybe omitted therefrom.

As a brake (braking device) for braking the fifth arm 16, a brake (not illustrated) is disposed in the vicinity of a shaft portion (output shaft) of the motor 405M. The brake can inhibit the shaft portion of the motor 405M from being pivoted, and can hold a posture of the fifth arm 16.

The fifth pivot shaft O5 may be parallel to an axis orthogonal to the fourth pivot shaft O4. The fifth pivot shaft O5 may not be orthogonal to the fourth pivot shaft O4. Both axial directions may be different from each other.

The fifth arm 16 and the sixth arm 17 are linked to each other via a joint 176. The joint 176 has a mechanism for supporting the fifth arm 16 and the sixth arm 17 which are linked to each other so that one is pivotable with respect to the other one. In this manner, the sixth arm 17 is pivotable around the center of a sixth pivot shaft O6 (around the sixth pivot shaft O6) with respect to the fifth arm 16. The sixth pivot shaft O6 is orthogonal to the fifth pivot shaft O5. The sixth arm 17 is pivoted (driven) around the sixth pivot shaft O6 by driving the sixth drive device 406 which has a motor (sixth motor) 406M serving as a drive unit (sixth drive unit) and a speed reducer (not illustrated) and which is mounted on a mounting surface of the sixth arm 17 and the mounting surface of the fifth arm 16. The sixth drive device 406 is driven by the motor 406M and a cable (not illustrated). The motor 406M is controlled by the control device via an electrically connected motor driver 306. The speed reducer may be omitted therefrom.

As a brake (braking device) for braking the sixth arm 17, a brake (not illustrated) is disposed in the vicinity of a shaft portion (output shaft) of the motor 406M. The brake can inhibit the shaft portion of the motor 406M from being pivoted, and can hold a posture of the sixth arm 17.

The sixth pivot shaft O6 may be parallel to an axis orthogonal to the fifth pivot shaft O5. The sixth pivot shaft O6 may not be orthogonal to the fifth pivot shaft O5. Both axial directions may be different from each other.

Without being particularly limited, for example, the motors 401M to 406M include a servo motor such as an AC servo motor and a DC servo motor.

Without being particularly limited, for example, the respective brakes include an electromagnetic brake.

In the illustrated configuration, the motor drivers 301 to 306 are disposed in the base 11. However, without being limited thereto, for example, the motor drivers 301 to 306 may be arranged in the control device.

As illustrated in FIGS. 7 to 11, as the flexible member having an elongated shape, the robot 1 has two cables 20 which internally has multiple wires. For example, the wire includes an electric wire. In this manner, compared to a case where the cable 20 is provided in one location, it is possible to cause the thickness of the cable 20 to be thinner, and it is possible to provide a thinner robot arm 6. For example, without being limited to two, the number of the cables 20 may be one or may be three or more.

The cables 20 are respectively disposed as described below. The respective cables 20 are similarly disposed. Accordingly, hereinafter, a representative one of the cables 20 will be illustrated and described as an example.

For example, without being limited to the cable 20, the flexible member includes a pipe. The pipe includes a tube (tubular body) through which a fluid such as air (gas) and water (liquid) passes. As the flexible member, both the cable 20 and the pipe may be provided. That is, the flexible member may have at least any one of the wire and the pipe.

As illustrated in FIG. 9, the cable 20 is disposed in a hollow portion of (inside) the first arm 12, a hollow portion of (inside) the second arm 13, a hollow portion of (inside) the third arm 14, and a hollow portion of (inside) the fourth arm 15 (only the fourth arm 15 is not illustrated). That is, the cable 20 is disposed so as to penetrate the respective hollow portions. The cable 20 has a folding portion 21a disposed in an outer periphery of the motor 401M, a first portion 22a, a second portion 23a, a folding portion 21b disposed in an outer periphery of the motor 402M, a first portion 22b, a second portion 23b, a folding portion 21c disposed in an outer periphery of the motor 403M, a first portion 22c, a second portion 23c, a folding portion disposed in an outer periphery of the motor 404M, a first portion, and a second portion (not illustrated). The respective folding portions are disposed in the cable 20 in this way. Accordingly, it is possible to effectively utilize an internal space of the robot arm 6.

The respective folding portions, the first portions, the second portions, and the configurations in the vicinity thereof are similar to each other. Accordingly, hereinafter, the folding portion 21b disposed in the outer periphery of the motor 402M, the first portion 22b, and the second portion 23b will be described as a representative example.

As illustrated in FIGS. 10 and 11, the folding portion 21b of the cable 20 is disposed in the outer periphery of the motor 402M so as to be folded in the circumferential direction of the shaft portion (output shaft) of the motor 402M, that is, in the circumferential direction of the second pivot shaft O2, and has a U-shape (folded in a U-shape).

The first portion 22b having an arc shape along the outer periphery of the motor 402M is disposed in one end portion of the folding portion 21b. An end portion 211 of the first portion 22b is fixed to a support member 45 of the motor 402M by a fixing member (first fixing portion) 441. The second portion 23b having an arc shape along the outer periphery of the motor 402M is disposed in the other end portion of the folding portion 21b. An end portion 212 of the second portion 23b is fixed to a pivot member 43 of the speed reducer which is pivotable with respect to the motor 402M by a fixing member (second fixing portion) 442. The pivot member 43 is fixed to the second arm 13, and the motor 402M is fixed to the first arm 12.

That is, the cable 20 has the folding portion 21b disposed between the fixing member 442 and the fixing member 441, the first portion 22b disposed between the fixing member 441 and the folding portion 21b, and the second portion 23b disposed between the fixing member 442 and the folding portion 21b. Then, the cable 20 is fixed to the first arm 12 by the fixing member 441, and is fixed to the second arm 13 by the fixing member 442.

In a case where the second arm 13 is pivoted by driving the motor 402M, the pivot member 43 is pivoted with respect to the motor 402M. In this case, the folding portion 21b is restrained from being twisted, thereby being bent and deformed. This relaxes stress acting on the cable 20. That is, in the folding portion 21b, it is possible to secure a large bending radius of the cable 20. In a case where the second arm 13 is pivoted, it is possible to restrain the cable 20 from being twisted or broken. In this manner, it is possible to restrain the cable 20 from being damaged, and it is possible to improve durability of the cable 20.

A case of one cable 20 has been described as an example. However, as described above, the robot 1 has two cables 20. The folding portion 21b of one cable 20 and the folding portion 21b of the other cable 20 are disposed to face each other. In this manner, it is possible to efficiently dispose the two folding portions 21b.

Next, a relationship of the first arm 12 to the sixth arm 17 will be described. The relationship will be described by changing expressions from various viewpoints. It is considered that the third arm 14 to the sixth arm 17 are in a state where these are stretched straight, that is, in a state where these are lengthened most, in other words, in a state where the fourth pivot shaft O4 and the sixth pivot shaft O6 are coincident with or parallel to each other.

First, as illustrated in FIG. 4, a length L1 of the first arm 12 is set to be longer than a length L2 of the second arm 13.

Here, the length L1 of the first arm 12 represents a distance between the second pivot shaft O2 and the center line 621 extending in the lateral direction in FIG. 4 of the bearing portion 62 for supporting the first arm 12 so as to be pivotable, when viewed in the axial direction of the second pivot shaft O2.

The length L2 of the second arm 13 represents a distance between the second pivot shaft O2 and the third pivot shaft O3, when viewed in the axial direction of the second pivot shaft O2.

As illustrated in FIG. 5, a configuration is adopted in which an angle θ formed between the first arm 12 and the second arm 13 can be 0°, when viewed in the axial direction of the second pivot shaft O2. That is, a configuration is adopted in which the first arm 12 and the second arm 13 can overlap each other, when viewed in the axial direction of the second pivot shaft O2. In this case, a configuration may be adopted in which at least a portion (first portion) of the first arm 12 and the second arm 13 can overlap each other.

Then, in a case where the angle θ is 0°, that is, in a case where the first arm 12 and the second arm 13 overlap each other when viewed in the axial direction of the second pivot shaft O2, the second arm 13 is configured so as not to interfere with the ceiling surface 531 of the ceiling 53 having the base 11, and the second portion 122 of the first arm 12. In a case where the proximal end surface of the base 11 is attached to the ceiling surface 531, the second arm 13 is similarly configured so as not to interfere with the ceiling surface 531 and the second portion 122 of the first arm 12.

Here, the angle θ formed between the first arm 12 and the second arm 13 represents an angle formed between a straight line (central axis of the second arm 13 in a case of being viewed in the axial direction of the second pivot shaft O2) 61 passing through the second pivot shaft O2 and the third pivot shaft O3, and the first pivot shaft O1, when viewed in the axial direction of the second pivot shaft O2.

The second arm 13 is pivoted without pivoting the first arm 12. In this manner, the distal end of the second arm 13 can be moved to a position different by 180° around the first pivot shaft O1, through a state where the angle θ is 0° (state where the first arm 12 and the second arm 13 overlap each other) when viewed in the axial direction of the second pivot shaft O2 (refer to FIG. 6). That is, the second arm 13 is pivoted without pivoting the first arm 12. In this manner, the distal end of the robot arm 6 (distal end of the sixth arm 17) can be moved from a left side position (first position) illustrated on the left side in FIG. 6, through a state where the angle θ is 0°, to a right side position (second position) illustrated on the right side in FIG. 6, which is different by 180° around the first pivot shaft O1 (refer to FIG. 6). The third arm 14 to the sixth arm 17 are respectively pivoted, when necessary.

When the distal end of the second arm 13 is moved to the position different by 180° around the first pivot shaft O1 (when the distal end of the robot arm 6 is moved from the left side position to the right side position), the distal end of the second arm 13 and the distal end of the robot arm 6 are moved on a straight line when viewed in the axial direction of the first pivot shaft O1.

A total length (maximum length) L3 of the third arm 14 to the sixth arm 17 is set to be longer than the length L2 of the second arm 13.

In this manner, the distal end of the sixth arm 17 can be protruded from the second arm 13, in a case where the second arm 13 and the third arm 14 overlap each other when viewed in the axial direction of the second pivot shaft O2. Accordingly, it is possible to restrain the hand 91 from interfering with the first arm 12 and the second arm 13.

Here, the total length (maximum length) L3 of the third arm 14 to the sixth arm 17 represents a distance between the third pivot shaft O3 and the distal end of the sixth arm 17 when viewed in the axial direction of the second pivot shaft (refer to FIG. 4). In this case, as illustrated in FIG. 4, the third arm 14 to the sixth arm 17 are in a state where the fourth pivot shaft O4 and the sixth pivot shaft O6 are coincide with or parallel to each other.

As illustrated in FIG. 5, a configuration is adopted in which the second arm 13 and the third arm 14 can overlap each other when viewed in the axial direction of the second pivot shaft O2.

That is, a configuration is adopted in which the first arm 12, the second arm 13, and the third arm 14 can simultaneously overlap each other when viewed in the axial direction of the second pivot shaft O2.

According to the robot 1, the above-described relationship is satisfied. Accordingly, the second arm 13 and the third arm 14 are pivoted without pivoting the first arm 12. In this manner, the hand 91 (distal end of the sixth arm 17) can be moved to the position different by 180° around the first pivot shaft O1, through a state where the angle θ formed between the first arm 12 and the second arm 13 is 0° (state where the first arm 12 and the second arm 13 overlap each other) when viewed in the axial direction of the second pivot shaft O2. Then, the robot 1 can be efficiently driven by using this operation. In addition, a space disposed in order to prevent interference with the robot 1 can be minimized, and various advantageous effects (to be described later) are achieved.

According to the robot 1, at least one of the first portion 22b and the second portion 23b of the cable 20 has a uniform portion both in a state where the motor 402M is driven (first state) and in a state where the motor 402M is not driven (second state). In this case, it is preferable that both the first portion 22b and the second portion 23b have the uniform portion.

The uniform portion of the cable 20 in the state where the motor 402M is driven and in the state where the motor 402M is not driven is a portion where a position is not changed in the first state and in the second state in the cable 20. That is, the uniform portion is a portion which is not moved even if the first state is changed to the second state in the cable 20. Hereinafter, the uniform portion is also referred to as a “stationary portion 24” (refer to FIG. 14). Description that the overall cable 20 is minutely moved or vibrated due to an operation or vibration of the robot 1 means that “the position is not changed” or “the position is not moved”.

Hereinafter, a case where the first portion 22b of the cable 20 has the uniform portion will be described as a representative example. However, the example is similarly applied to a case where the second portion 23b of the cable 20 has the uniform portion. It is considered that all the length of the cable 20 represents the length in the longitudinal direction of the cable 20. The longitudinal direction of the cable 20 represents a direction of the central axis of the cable 20, and represents a direction along the bent cable 20 in a case where the cable 20 is bent.

As illustrated in FIGS. 12, 13, and 14, when the maximum pivot angle of the second arm 13 around the second pivot shaft O2 is set to θ(°), the outer diameter of the portion having the folding portion 21b, the first portion 22b, and the second portion 23b of the cable 20 inside the robot arm 6 is set to X, the inner diameter having the folding portion 21b, the first portion 22b, and the second portion 23b of the cable 20 inside the robot arm 6 is set to D, the length in the axial direction of the second pivot shaft O2 of the portion having the folding portion 21b, the first portion 22b, and the second portion 23b of the cable 20 inside the robot arm 6 is set to Y, the diameter (bundle diameter) of the cable 20 is set to Z, the length of the cable 20 in the direction perpendicular to the axial direction of the second pivot shaft O2 of the cable 20 which is required for fixation using the fixing member 441 is set to C, θ, X, Y, Z, and C are respectively set so as to satisfy Expression (1) below. That is, the robot 1 is designed so that X, Y, Z, and C respectively satisfy Expression (1) below. The second arm 13 is controlled so that θ(°) is an upper limit value.

[(X−Z)×π/2−Y/2]−[(X−Z)×π/4×θ180]−C>0 (1)

provided that (X−D)/2>Z

The cable 20 is disposed over 180° around the second pivot shaft O2 as the central angle.

According to the embodiment, an absolute value of θ is set to a value which is smaller than 360°. However, without being limited thereto, the absolute value may be set to a value which is equal to or greater than 360°.

In a case where the second portion 23b has the uniform portion, “C” above is replaced with “the length of the cable 20 which is required for fixation using the fixing member 442”.

Here, Expression (1) above indicates that the stationary portion 24 (refer to FIG. 14) is present (is not “0”) even in a case where the second arm 13 is pivoted by θ(°) which is the maximum pivot angle.

Therefore, since Expression (1) above is satisfied in the robot 1, it is possible to restrain an excessive load from being applied to the cable 20 in a case where the robot 1 is operated. According to this configuration, in a case where the robot 1 is operated, it is possible to restrain the cable 20 from being disconnected at an early stage. In addition, it is possible to effectively utilize the internal space of the robot arm 6.

Expression (1) above is derived as follows.

First, it is necessary that a value obtained by subtracting “a movement amount B of the folding portion 21b moved in a case where the second arm 13 is pivoted by θ(°)” from “one side cable length A” illustrated in FIG. 14 is greater than “a length C of the cable 20 required for fixation”.

The above-described relationship is expressed by Expression (2) below.

A−B−C>0 (2)

“The one side cable length A” is “(X−Z)×π/2−Y/2”.

In this case, the length of the cable 20 which corresponds to 180° around the second pivot shaft O2 as the central angle in a case of considering the center line (center) of the cable 20 is “(X−Z)×π/2”. With regard to “(X−Z)”, refer to FIG. 13.

Then, “the one side cable length A” is the value obtained by subtracting “Y/2” from “(X−Z)×π/2”, and thus, the above equation is satisfied.

A movement amount of one end portion of the cable 20 which is moved in a case where the second arm 13 is pivoted by 180 (°) is “(X−Z)×π/2”. Therefore, a movement amount of the folding portion 21b in the case where the second arm 13 is pivoted by 180 (°) is ½ of the above equation, that is, “(X−Z)×π/4”.

Therefore, “the movement amount B of the folding portion 21b moved in a case where the second arm 13 is pivoted by θ(°)” is “(X−Z)×π/4×θ/180”.

If these are substituted into Expression (2) above, Expression (1) above is derived.

Here, the left side of Expression (1) above represents the length of the stationary portion 24 in a case where the second arm 13 is pivoted by θ(°) which is the maximum pivot angle.

The length of the stationary portion 24 maybe longer than “0”. However, it is preferable that the length of the stationary portion 24 is longer than a radius (Z/2) of the cable 20, and more preferable that the length of the stationary portion 24 is longer than the diameter (Z) of the cable 20. In this manner, it is possible to more reliably restrain an excessive load from being applied to the cable 20 in a case where the robot 1 is operated.

If the length is defined by other criteria, it is preferable that the length of the stationary portion 24 is longer than 3 mm, and more preferable that the length of the stationary portion 24 is longer than 5 mm. It is much more preferable that the length of the stationary portion 24 is equal to or longer than 10 mm. In this manner, it is possible to more reliably restrain an excessive load from being applied to the cable 20 in a case where the robot 1 is operated.

The upper limit value of the length of the stationary portion 24 is not particularly limited, and is appropriately set depending on various conditions. However, it is preferable that the length of the stationary portion 24 is shorter than a half of [(X−Z)×π/2−Y/2]. In this manner, it is possible to restrain the length of the stationary portion 24 from becoming unnecessarily longer, and to restrain the required internal space of the robot arm 6 from being widened in order to install the cable 20. In this manner, it is possible to provide the thinner robot arm 6.

If the length is defined by other criteria, it is preferable that the length of the stationary portion 24 is shorter than 30 mm, and more preferable that the length of the stationary portion 24 is shorter than 20 mm. It is much more preferable that the length of the stationary portion 24 is equal to or shorter than 15 mm. In this manner, it is possible to restrain the length of the stationary portion 24 from becoming unnecessarily longer, and to restrain the required internal space of the robot arm 6 from being widened in order to install the cable 20. In this manner, it is possible to provide the thinner robot arm 6.

Next, description will be continued using a specific example.

For example, as the specific example, the length of the stationary portion 24 and the length C of the cable 20 in the direction perpendicular to the axial direction of the second pivot shaft O2 which is required for fixation using the fixing member 441 are respectively set to approximately 5 mm. The robot 1 is designed so that 110 mm<X, Y<75 mm, and Z<15 mm are satisfied in order to secure ±200° as the maximum pivot angle θ of the second arm 13 around the second pivot shaft O2.

According to this setting, the portion of the cable 20 which is fixed using the fixing member 441 is not pulled even if the second arm 13 is pivoted by ±200° around the second pivot shaft O2. Therefore, it is possible to restrain an excessive load from being applied to the cable 20 when the second arm 13 is pivoted.

As described above, according to the robot 1, it is possible to restrain an excessive load from being applied to the cable 20 in a case where the robot 1 is operated. According to this configuration, in a case where the robot 1 is operated, it is possible to restrain the cable 20 from being disconnected at an early stage. In addition, it is possible to effectively utilize the internal space of the robot arm 6 (robot 1).

As described above, in the robot 1, the second arm 13 and the third arm 14 are pivoted without pivoting the first arm 12. In this manner, the hand 91 (distal end of the robot arm 6) can be moved to a position different by 180° around the first pivot shaft O1, through a state where the angle θ formed between the first arm 12 and the second arm 13 is 0° (state where the first arm 12 and the second arm 13 overlap each other) when viewed in the axial direction of the second pivot shaft O2.

In this manner, a space disposed in order to prevent interference with the robot 1 can be minimized.

That is, the ceiling 53 can be first lowered. In this manner, a position of the center of gravity of the robot 1 is lowered, and thus, it is possible to minimize the influence of the vibration of the robot 1. That is, it is possible to restrain the vibration generated due to the reaction force applied by the operation of the robot 1.

It is possible to minimize an operation region in the width direction (production line direction) of the robot 1. According to this configuration, the more robots 1 can be arranged per unit length along a production line, and thus, the production line can be shortened.

In a case where the distal end of the robot arm 6 is moved, the movement of the robot 1 can be minimized. For example, the first arm 12 is not pivoted, or the pivot angle of the first arm 12 can be minimized. In this manner, a tact time can be shortened, and work efficiency can be improved.

If an operation for moving the distal end of the robot arm 6 to a position different by 180° around the first pivot shaft O1 (hereinafter, referred to as a “shortcut motion”) is intended to be performed by simply pivoting the first arm 12 around the first pivot shaft O1 as in the robot in the related art, there is a possibility that the robot 1 may interfere with a wall (not illustrated) in the vicinity thereof or a peripheral device (not illustrated) thereof. Accordingly, it is necessary to teach the robot 1 an evacuation point for avoiding the interference. For example, in a case where the robot 1 interferes with the wall if only the first arm 12 is rotated by 90° around the first pivot shaft O1, it is necessary to teach the robot 1 the evacuation point so as not to interfere with the wall by also pivoting other arms. Similarly, in a case where the robot 1 also interferes with the peripheral device, it is necessary to further teach the robot 1 the evacuation point so as not to interfere with the peripheral device. According to the robot in the related art, it is necessary to teach the robot many evacuation points. In particular, in a case where the peripheral space of the robot 1 is small, it becomes necessary to teach the robot 1 a huge number of evacuation points. Consequently, it takes a lot of efforts and a long time in teaching the robot 1 the evacuation points.

In contrast, according to the robot 1, in a case where the above-described shortcut motion is performed, a region or a portion which causes the interference is very small. Accordingly, it is possible to reduce the evacuation points to be taught, and it is possible to reduce the effort and time which are required for teaching. That is, according to the robot 1, for example, the number of evacuation points to be taught is approximately ⅓ of that according to the robot in the related art. Therefore, the teaching is significantly facilitated.

A region (portion) 101 of the third arm 14 and the fourth arm 15, which is surrounded by a two-dot chain line on the right side in FIG. 3, is a region (portion) where the robot 1 does not interfere with or is less likely to interfere with the robot 1 itself and other members. Therefore, in a case where a predetermined member is mounted on the region 101, the member is less likely to interfere with the robot 1 and the peripheral device. Therefore, according to the robot 1, the predetermined member can be mounted on the region 101. In particular, in a case where the predetermined member is mounted on a region of the third arm 14 on the right side in FIG. 3 within the region 101, probability that the member may interfere with the peripheral device (not illustrated) disposed on a work table (not illustrated) is further lowered. Therefore, this configuration is more effectively adopted.

For example, those which can be mounted on the region 101 include the hand, the control device for controlling the drive of a sensor such as a hand-eye camera, and an electromagnetic valve of a suction mechanism.

For example, as a specific example, in a case where the suction mechanism is disposed in the hand, if the electromagnetic valve is installed in the region 101, the electromagnetic valve does not hinder the robot 1 when the robot 1 is driven. In this way, the region 101 is very conveniently used.

Hitherto, the robot according to the invention has been described with reference to the illustrated embodiment. However, the invention is not limited thereto, and a configuration of each unit can be replaced with any desired configuration having the same function. Any other desired configuration may be added thereto.

In the above-described embodiment, the fixing location of the base of the robot is the ceiling. However, the invention is not limited thereto. For example, in addition to the ceiling, the fixing location includes a floor, a wall, a work table, and the ground in the installation space. The robot may be installed inside a cell. In this case, the fixing location of the base is not particularly limited. For example, the fixing location includes a ceiling portion, a wall portion, a work table, and a floor of the cell.

In the above-described embodiment, the surface to which the robot (base) is fixed is a plane (surface) parallel to a horizontal plane. However, the invention is not limited thereto. For example, the surface may be a plane (surface) inclined with respect to the horizontal plane or a vertical plane, or may be a plane (surface) parallel to the vertical plane. That is, the first pivot shaft may be inclined with respect to the vertical direction or the horizontal direction. Alternatively, the first pivot shaft may be parallel to the horizontal direction.

In the above-describe embodiment, the first arm and the second arm can overlap each other when viewed in the axial direction of the second pivot shaft. However, the invention is not limited thereto. The first arm and the second arm cannot overlap each other when viewed in the axial direction of the second pivot shaft.

In the above-describe embodiment, the end effector includes the hand as an example. However, the invention is not limited thereto. For example, in addition to the hand, the end effector includes a drill, a welding machine, and a laser emitter.

In the above-describe embodiment, the number of the pivot shafts of the robot arm is six. However, the invention is not limited thereto. For example, the number of the pivot shafts of the robot arm may be two, three, four, five, seven or more. That is, in the above-described embodiment, the number of the arms (links) is six. However, the invention is not limited thereto. For example, the number of the arms may be two, three, four, five, seven or more. In this case, for example, an arm is additionally disposed between the second arm and the third arm in the robot according to the above-described embodiment. In this manner, it is possible to realize a robot which has seven arms.

According to the invention, the pivotable angles of the respective arms are not particularly limited. For example, the respective arms may be pivotable by ±360° or larger.

In the above-describe embodiment, the respective arms are disposed so as to be pivotable. However, the invention is not limited thereto. For example, the respective arms may be disposed so as to be displaceable (operable) or movable in a straight line shape or in a curved shape.

In the above-describe embodiment, the arm disposed in the base is the first arm. However, the invention is not limited thereto. Any arm excluding the arm disposed on the most distal end side may be the first arm.

In the above-describe embodiment, the number of the robot arms is one. However, the invention is not limited thereto. For example, the number of the robot arms may be two or more. That is, for example, the robot (robot main body) may be a multiple arm robot such as a dual arm robot.

According to the invention, the robot (robot main body) may be another type robot. For example, a specific example includes a leg walking (travelling) robot which has a leg portion and a horizontally articulated robot such as a scalar robot.

The entire disclosure of Japanese Patent Application No. 2016-011298, filed Jan. 25, 2016 is expressly incorporated by reference herein.

What is claimed is:

1. A robot comprising:
a first arm that has a drive unit;
a second arm that is disposed in the first arm, and that can be displaced with respect to the first arm by the drive unit; and
a flexible member that is fixed to the first arm by a first fixing portion, and that is fixed to the second arm by a second fixing portion,
wherein the flexible member has a folding portion disposed between the first fixing portion and the second fixing portion, a first portion disposed between the first fixing portion and the folding portion, and a second portion disposed between the second fixing portion and the folding portion, and
wherein at least one of the first portion and the second portion has a uniform portion both in a state where the drive unit is driven and in a state where the drive unit is not driven.

2. The robot according to claim 1,
wherein the flexible member has an elongated shape, and
wherein a longitudinal length of the uniform portion is longer than a radius of the flexible member.

3. The robot according to claim 1,
wherein the flexible member has an elongated shape, and
wherein a longitudinal length of the uniform portion is longer than a diameter of the flexible member.

4. The robot according to claim 1,
wherein the flexible member has an elongated shape, and
wherein a longitudinal length of the uniform portion is longer than 3 mm.

5. The robot according to claim 1,
wherein the flexible member has an elongated shape,
wherein the second arm is disposed in the first arm so as to be pivotable around a pivot shaft, and
wherein when an outer diameter of a portion having the folding portion, the first portion, and the second portion is set to X, a length in an axial direction of the pivot shaft of the portion having the folding portion, the first portion, and the second portion is set to Y, and a diameter of the flexible member is set to Z, a longitudinal length of the uniform portion is shorter than a half of [(X−Z)×π/2−Y/2].

6. The robot according to claim 1,
wherein the flexible member is provided at two locations.

7. The robot according to claim 6,
wherein the folding portion of one flexible member and the folding portion of the other flexible member are disposed so as to face each other.

8. The robot according to claim 1,
wherein the flexible member has at least one of a wire and a pipe.

9. The robot according to claim 1,
wherein the first arm is pivotable around a first pivot shaft, and
wherein the second arm is pivotable around a second pivot shaft.

10. The robot according to claim 1,
wherein the flexible member has an elongated shape,
wherein the second arm is disposed in the first arm so as to be pivotable around a pivot shaft, and
wherein when the maximum pivot angle of the second arm is set to θ(°), an outer diameter of a portion having the folding portion, the first portion, and the second portion is set to X, a length in an axial direction of the pivot shaft of the portion having the folding portion, the first portion, and the second portion is set to Y, a diameter of the flexible member is set to Z, and a length of the flexible member in a direction perpendicular to an axial direction of the pivot shaft, which is required for fixation using the first fixing portion or the second fixing portion is set to C, the above-described θ, X, Y, Z, and C are set to satisfy Expression (1) below.
[(X−Z)×π/2−Y/2]−[(X−Z)×π/4×θ/180]−C>0 (1)
